(19) United States
(12) Patent Application Publication
(10) Pub. No.: US 2014/0094279 A1
(43) Pub. Date: Apr. 3, 2014

(54) Apparatus, System and Method for Providing a Community Wagering Game at a Gaming Machine

(71) Applicants: Dennis Lockard, Pleasanton, CA (US); Bryan Kelly, Pleasanton, CA (US); Martin Lyons, Las Vegas, NV (US)

(72) Inventors: Dennis Lockard, Pleasanton, CA (US); Bryan Kelly, Pleasanton, CA (US); Martin Lyons, Las Vegas, NV (US)

(21) Appl. No.: 13/919,587

(22) Filed: Jun. 17, 2013

Related U.S. Application Data
(60) Provisional application No. 61/707,554, filed on Sep. 28, 2012.

(51) Int. Cl. G07F 17/32; A63F 13/12

(52) U.S. Cl. CPC G07F 17/3272; G07F 17/3258; A63F 13/12
USPC 463/25

(57) ABSTRACT

A system, method and apparatus are set forth for providing a system-wide competitive game where players of gaming devices may wager upon the game. In an embodiment the game is a competitive racing game such as an auto race. Players wager upon a race competitor and those players wagering upon the winning contestant are issued an award. The system and method provides a mechanism for sharing the award among the winning players

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### CROSS-REFERENCE TO RELATED APPLICATION

This application is a regular utility patent application which claims the benefit of prior filed U.S. Provisional Patent Application Ser. No. 61/707,554 filed Sep. 28, 2012 the disclosure of which is incorporated by reference.

### BACKGROUND OF THE INVENTION

1. Field of the Invention

The field of the invention relates to systems and methods which provide wagering games to players. More particularly it relates to systems and methods which provide a system configured game for community play across a plurality of electronic gaming devices.

2. Background

Various types of gaming machines have been developed with features designed to captivate and maintain player interest. In general, a gaming machine allows a player to play a game of chance in exchange for a wager. Depending on the outcome of the game, the player may be entitled to an award which is paid to the player by the gaming machine, normally in the form of currency or game credits. Gaming machines may include flashing displays, lighted displays or sound effects to capture a player's interest in a gaming device.

Another important feature of maintaining player interest in a gaming machine includes providing the player with many opportunities to win awards such as cash or prizes. For example, in some slot machines, the display windows show more than one adjacent symbol on each reel, thereby allowing for multiple-line betting. Some gaming machines offer a player an opportunity to win millions large prizes by providing progressive jackpots. Additionally, feature games of various types have been employed to reward players above the amounts typically awarded on a standard game pay schedule. Generally, such feature games are triggered by predetermined events such as one or more appearances of certain combinations of indicia in a primary game. In order to simulate interest, feature games are typically set to occur at a gaming machine on a statistical cycle based upon the number of primary game plays.

While gaming machines, including feature games, have been very successful, there remains a need for games that provide a player with enhanced excitement and increased opportunity of winning.

In modern casino enterprises, which may include several physical casino venues, players may enroll in the casino loyalty program. The casino enterprise includes a communication network by which an operator can monitor player activity such as wagers, jackpots, games played and the like. Players are identified typically thought the player's use of a loyalty card having a machine readable stripe. For a brick and mortar casino an example of such a system is the Bally CMS® system sold by Bally Technologies, Inc. of Las Vegas, Nev. These systems interface with card readers at gaming terminals and table game input devices to provide the aforesaid tracking functions. Based upon the data collected the casino can provide bonuses to players in the way of benefits and incentives to retain a player's loyalty by, for example, awarding “comps” in the form of cash back, discounts for goods, lodging, services and gifts or points which can be exchanged for the foregoing. The tracking can be restricted to a single enterprise venue or can be on a national basis such as described in Boushy, U.S. Pat. No. 7,419,427 issued Sep. 2, 2008 and titled “National Customer Recognition System and Method”, the disclosure of which is incorporated by reference. The level of “comps” available to the player is related to the player's rating which acts to quantify the value of the player to the casino. A higher rated player is one who spends and gambles more than a lower rated player. A higher rated player is entitled to more valuable or additional comps.

Many casino enterprises also have a presence in electronic media such as by having commercial websites and social media sites accessible via the Internet or through broadband communication devices such as cellular telephones, smart phones, tablet computes and other devices.

There is an ever growing need to enhance the loyalty of customers/players in addition to offering such existing loyalty programs. There is a need to foster loyalty between players and the enterprise through activity associated with the “brick and mortar” casino venue as well as through associated electronic media.

There is a need to provide entertainment in association with the objective of enhancing player loyalty. Entertainment may be by means of compelling graphics and animations, prizes and awards.

There is a need to provide for supplemental wagering opportunities to players playing gaming machines which may be in the form of a casino or enterprise-wide game such as a competitive game. There is a need for providing a casino or enterprise-wide game such as a competitive game which will provide incentives to players to retire awarded “comp” points. The comp points provided to players, as described above, have a value which is carried by the enterprise as a liability. This liability may be retired by the player redeeming the points to purchase goods/services.

The foregoing examples of the related art and limitations related therewith are intended to be illustrative and not exclusive. Other limitations of the related art will become apparent to those of skill in the art upon a reading of the specification and a study of the drawings. Additionally, limitations and disadvantages of the related art may become apparent from review of other related art itself.

### SUMMARY OF THE INVENTION

There is, therefore, set forth according to the present invention, there is set forth a system and method which provides a community game to provide players with additional wagering opportunities.

The system and method is directed to a community game associated with gaming devices of the type provided for play by casino enterprises for pay-to-play (P2P) wagering games or for entertainment-only play. A server and apparatus are configured to receive and communicate an entry by players into the game, which may require risking a wager amount (w) or may be wagering virtual credits or “comp” related points. A community game is triggered, which may be for example a competitive racing game and the game may require assignment of the participating player to one of the competitors. The community game is conducted to result in a winning outcome such as only of the virtual competitors winning the competitive game. The server is configured to resolve the awards among winning players.

In one or more embodiments the competitive game may be spinning reel game.

### BRIEF DESCRIPTION OF THE DRAWINGS

FIG. 1 illustrates a gaming terminal;

FIGS. 2A-B illustrate an example of a gaming terminal operational platform and components for a gaming terminal of the type of the present invention;

FIG. 3 is a block diagram of the logical components of a gaming kernel for a gaming terminal.

FIGS. 4A and 4B is a schematic of an example of a casino enterprise network incorporating gaming terminals;

FIG. 5 is a diagram showing an example of an architecture for tying a casino enterprise network to an external provider of games and content to Internet or broadband communication capable devices;

FIG. 6 shows an embodiment of a display presenting a player with the opportunity to participate in a community game, a display window for the community game and community game information;

FIG. 7 is a logic diagram directed to an overview of the play of a base game and a community game;

FIG. 8 is a logic diagram for the community game process; and

FIGS. 9-16 are samples of displays for the presentation of the community game.

### DETAILED DESCRIPTION

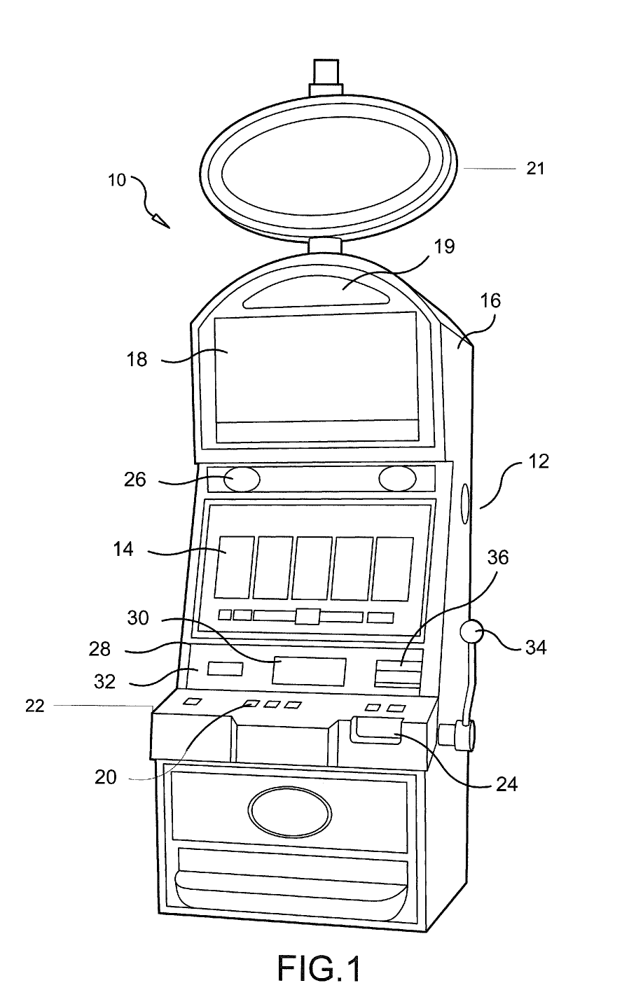

Referring now to the drawings, wherein like reference numbers denote like or corresponding elements throughout the drawings, and more particularly referring to FIG. 1, a gaming device 10 according to one or more embodiments of the present invention is shown. The gaming device 10 includes cabinet 12 providing an enclosure for the several components of the gaming device 10 and associated equipment. A primary game display 14 is mounted to the cabinet 12. The primary game display 14 may be a video display such as an LCD, plasma, OLED or other electronic display or it may be an electro-mechanical display such as electro-mechanical stepper reels as are known in the art. The primary game display 14 may also be embodied as a combination of two or more electronic or mechanical displays disposed in an adjacent overlapping or overlying arrangement. The primary game display 14 may be mounted to one or more of a door for the cabinet 12 or the cabinet chassis itself. The primary game display 14 is located to display game content (and if desired other content) to the player. For example, the game content may be base game outcomes presented by a plurality of video or electro-mechanical spinning reels displaying symbols the combinations of which define winning or losing outcomes, video Poker, Keno or other form of base casino wagering game as is known in the art. While the following description of the various embodiments of the present invention is directed to video reel-spinning games, it should be understood that the invention could be applied to other games as well. Where the primary game display 14 is a video display, features such as bonus/feature games may also be presented s hereinafter described. The foregoing description should not be deemed as limiting the content (graphics, video or text) which can be displayed at the primary game display 14. The cabinet 12 may comprise a slant-top, bar-top, or table-top style cabinet as is known in the art.

The gaming device 10 also includes in one or more embodiments a top box 16 which may support a printed back-lit glass (not shown) as is known in the art depicting the rules, award schedule, attract graphics or it may support a secondary game display 18 which may be of one of the types described above with reference to the primary game display 14. The top box 16 may also support a backlit glass with graphics defining a marquee 19 and a topper 21 including additional graphics.

To enable a player to provide input to the controller for the gaming device 10 a plurality of buttons 20 may be provided on a button deck 22 for the gaming device 10. Additionally and alternatively one or both of the primary and secondary game displays 14, 18 may include touch screen input interface(s) as are known in the art. Buttons, selections or inputs are displayed at the primary and secondary game displays 14, 18 and the player touching those icons or designated areas provides the required or desired input to configure and play the gaming device 10. The buttons 20 may be displayed and defined at a touch screen button panel interface of the type described in Kelly et al U.S. Pub. 2010/0113140A1 filed Nov. 16, 2009, the disclosure of which is incorporated herein.

Other peripherals or associated equipment for the gaming device 10 include a bill/voucher acceptor 24 which reads and validates currency and vouchers for the player to establish credits for gaming on the gaming device 10 and one or more speakers 26 to provide audio to the player in association with the game play. To provide for communication between the gaming device 10 and a casino system, a player tracking module (PTM) 28 is mounted on the cabinet 12. PTM 28 has a PTM display 30 to display system related information to the player. The PTM display 30 may be a small LCD, plasma or OLED display with touch screen functionality. In an embodiment the community games and features described herein are displayed at the PTM display 30; however, as set forth below these presentations are preferably migrated to areas at the primary or secondary displays 14, 18. A card reader 32 is provided to read a machine readable component on a player loyalty card issued to the player to identify the player to the casino system as in known in the art. A ticket printer 36 may be provided as well on the PTM 28 or elsewhere on the gaming device 10 to provide printed value ticket vouchers to players as is known in the art.

Some functionality of the PTM 28 may be provided by a video switcher and touch router device as is described in U.S. Pub. App. 2009/0149253 entitled “Video Switcher and Touch Router Method for a Gaming Machine” filed Jan. 8, 2009 and incorporated by reference. System and externally based content including the community game presentations as hereinafter described, player information, advertisements or other information may be displayed at areas at one or more of the primary or secondary displays 14, 18 dispensing with the need for the PTM display 30. Accordingly it should be understood that the virtual objects and accessories described herein could be displayed at regions at one or more of the primary or secondary displays 14, 18. According to the disclosure of U.S. Pub. App. 2009/0149253 when system content as well as the community game(s) described herein are presented at the primary game display 14, the presentation of the base game played by the player is sized to share display real estate with the system content and/or community game as hereinafter described

While the player may use the buttons 20 to prompt play of the game (or the touch screen input), alternatively the player may use a handle 34 to prompt an input as is known in the art.

Cabinet 12 may be a self-standing unit that is generally rectangular in shape and may be manufactured with reinforced steel or other rigid materials which are resistant to tampering and vandalism. Any shaped cabinet may be implemented with any embodiment of gaming device 10 so long as it provides access to a player for playing a game. For example, cabinet 12 may comprise a slant-top, bar-top, or table-top style cabinet, including a Bally Cinevision™ or CineReels™ cabinet. The gaming device 10 may include a controller and memory disposed within the cabinet 12 or may have thin client capability such as that some of the computing capability is maintained at a remote server.

The plurality of player-activated buttons at the button deck 22 may be used for various functions such as, but not limited to, selecting a wager denomination, selecting a game to be played, selecting a wager amount per game, initiating a game, or cashing out money from gaming machine 10. Buttons may be operable as input mechanisms and may include mechanical buttons, electromechanical buttons or touch screen buttons. In one or more embodiments, buttons 22 may be replaced with various other input mechanisms known in the art such as, but not limited to, touch screens, touch pad, track ball, mouse, switches, toggle switches, or other input means used to accept player input. For example, one input means is as disclosed in U.S. Pub. App. 2011/0111853, entitled “Universal Button Module,” filed on Jan. 14, 2011 and/or U.S. Pub. App. 2010/0113140 entitled “Gesture Enhanced Input Device” filed Nov. 16, 2009 which are hereby incorporated by reference. Player input may also be by providing touch screen functionality at the primary game display 14 and/or secondary game display 18.

The primary game display 14, according to the present invention, is controlled to present at least one instance of a base game of chance wherein a player receives one or more outcomes from a set of potential outcomes. For example, one such game of chance is a video slot machine game. In other aspects of the invention, gaming machine 10 may present a video or mechanical reel slot machine, a video keno game, a lottery game, a bingo game, a Class II bingo game, a roulette game, a craps game, a blackjack game, a mechanical or video representation of a wheel game or the like. As more fully described below the primary game display 14 may be controlled to present and play multiple instances of concurrent games.

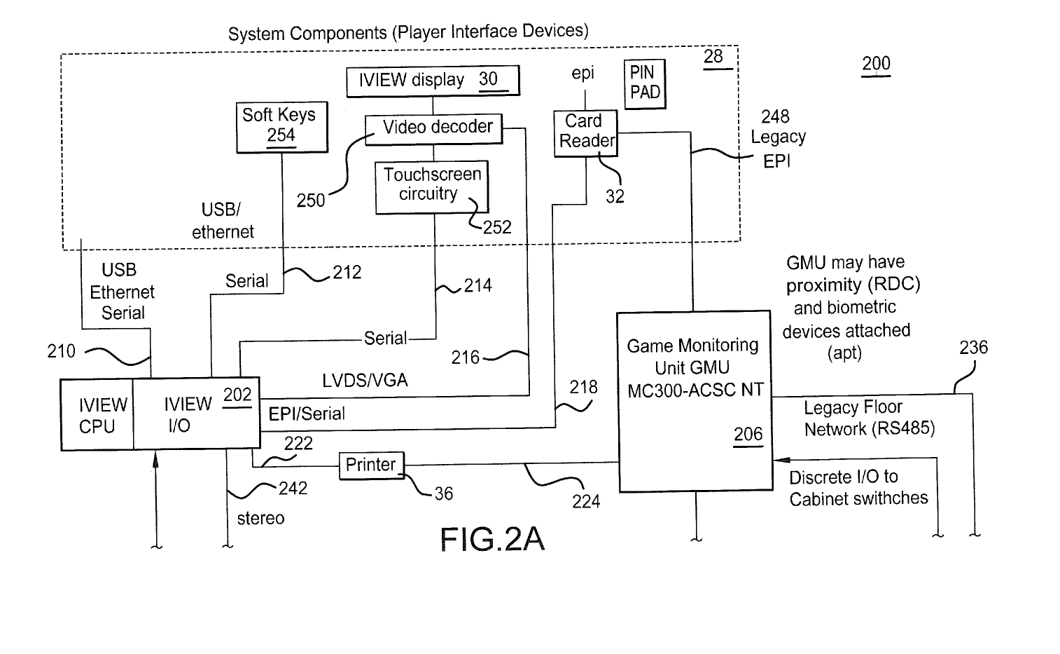

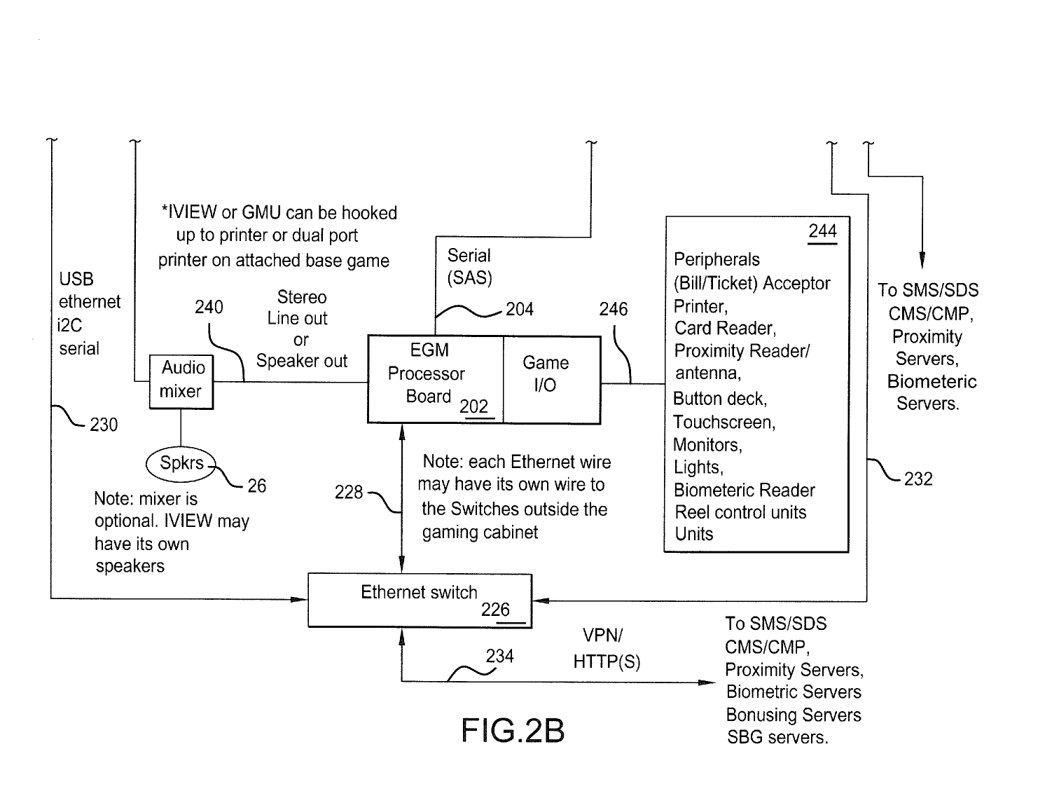

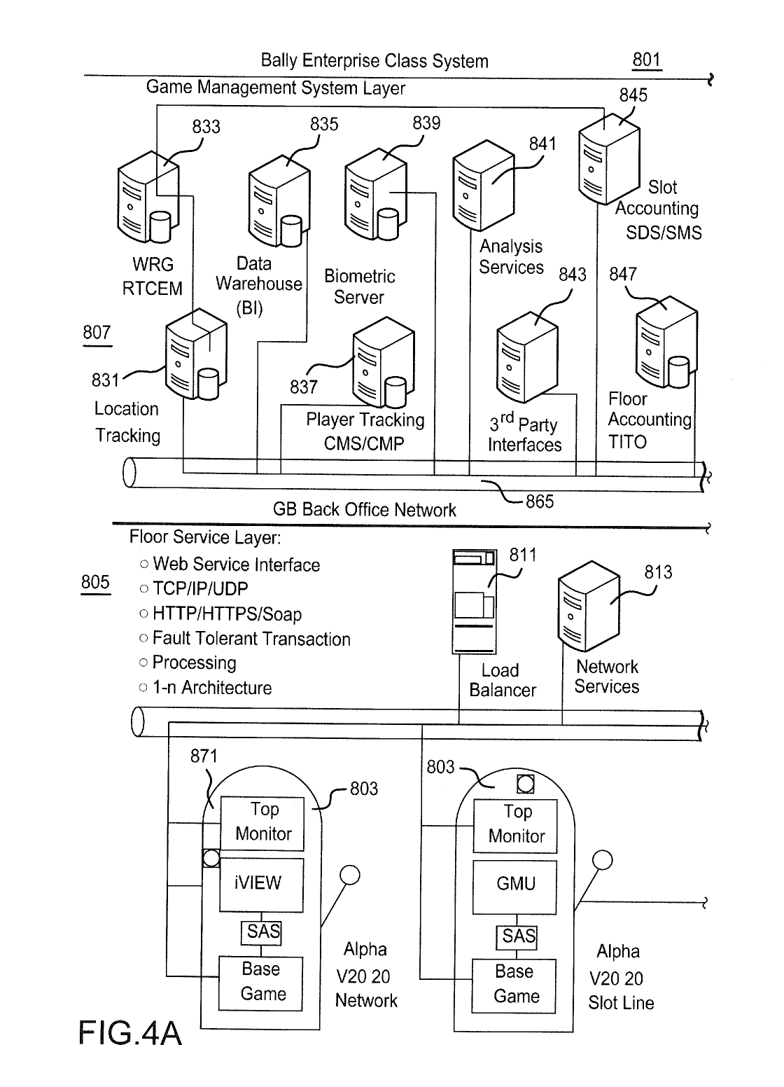

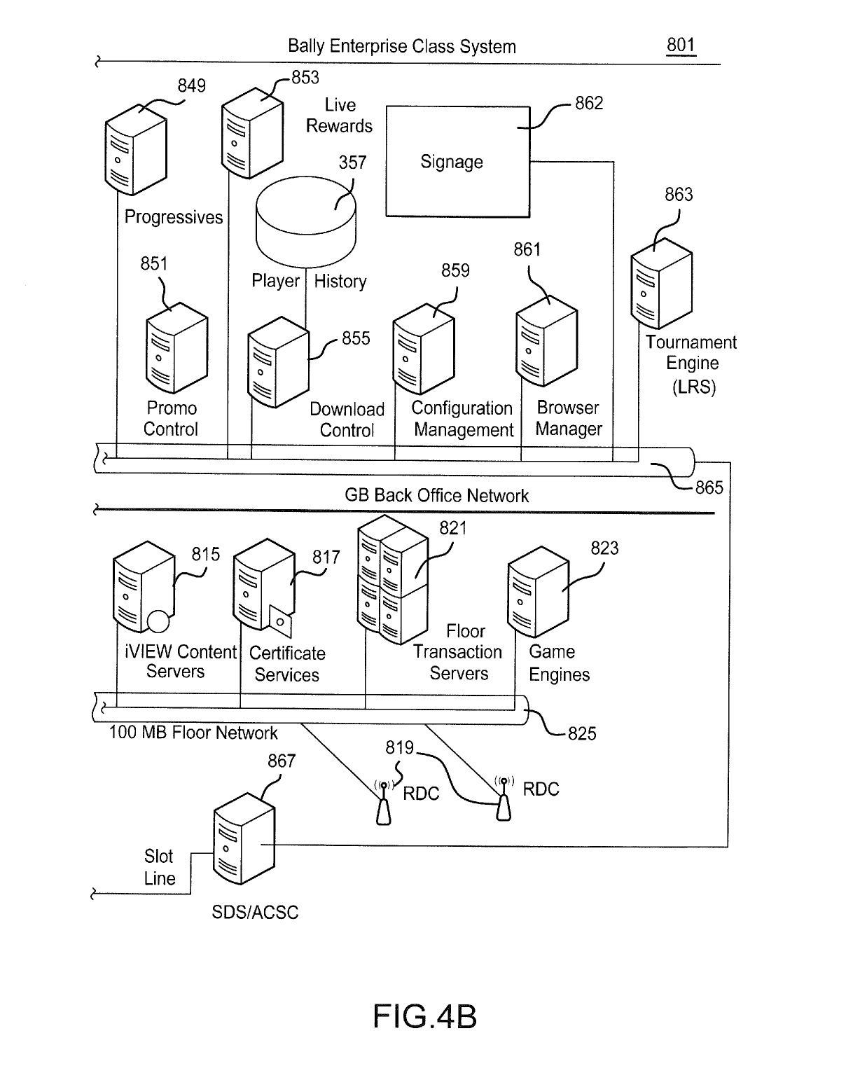

Referring to FIGS. 2A, B, the gaming device 10 hardware 200 for the controller(s) is shown in accordance with one or more embodiments. The hardware 200 includes base game processor board 202 (EGM Processor Board) connected through serial bus line 204 to game monitoring unit (GMU) 206 (such as a Bally MC300 or ACSC NT manufactured and sold by Bally Gaming, Inc., Las Vegas, Nev.), and player interface CPU/input-output device 202 (CPU 202) connected to the player tracking module (PTM) 28 over bus lines 210, 212, 214, 216, 218. The PTM 28 provides for communication between one or more gaming devices 10 and the casino system such as the type as hereinafter described. Inasmuch as gaming devices 10 may be manufactured by different entities, mounting like PTMs 28 at each gaming device 10 provides for communication to the system in one or more common message protocols. Typically when a casino enterprise purchases a casino management system they also purchase the same manufacturer's PTMs 28 and video switcher and touch router such as a DM (display manager) device or the type sold by Bally Gaming, Inc. of Las Vegas, Nev. which are then installed by the various manufacturers of the gaming devices for the enterprise before delivery. In this manner the mountings for the PTMs 28 on the gaming devices can be configured for location and esthetic appearance. Gaming voucher ticket printer 36 (for printing player cash out tickets) is connected to PIB 208 and GMU 206 over bus lines 222, 224. EGM Processor Board 202, CPU 202, and GMU 206 connect to Ethernet switch 226 over bus lines 228, 230, 232. Ethernet switch 226 connects to a slot management system and a casino management system (SMS, SDS, CMS and CMP) (FIGS. 4A, 4B) network over bus line 234. Ethernet switch 226 may also connect to a server based gaming server or a downloadable gaming server. GMU 206 also may connect to the network over bus line 236. Speakers 26 to produce sounds related to the game or according to the present invention connect through audio mixer and bus lines 240, 242 to EGM Processor Board 202 and PIB 208.

Peripherals 244 connect through bus 246 to EGM Processor Board 202. The peripherals 244 include, but are not limited to the following and may include individual processing capability: bill/voucher acceptor 24 to validate and accept currency and ticket vouchers, the player interfaces such a buttons 20, primary and secondary game displays 14, 18 and any secondary or tertiary displays (with/without) touch screen functionality, monitors and lights. The peripherals 244 may include the displays as hereinafter described with reference to the various embodiments of the present invention as herein described or their equivalents. For example, the bill/voucher acceptor 24 is typically connected to the game input-output board of the EGM processing board 202 (which is, in turn, connected to a conventional central processing unit (“CPU”) board), such as an Intel Pentium® microprocessor mounted on a gaming motherboard. The I/O board may be connected to CPU processor board by a serial connection such as RS-232 or USB or may be attached to the processor by a bus such as, but not limited to, an ISA bus. The gaming motherboard may be mounted with other conventional components, such as are found on conventional personal computer motherboards, and loaded with a game program which may include a gaming machine operating system (OS), such as a Bally Alpha OS. EGM processor board 202 executes a game program that causes the gaming device 10 to display and play a game. The various components and included devices may be installed with conventionally and/or commercially available components, devices, and circuitry into a conventional and/or commercially available gaming terminal cabinet 12.

When a player has inserted a form of currency such as, for example and without limitation, paper currency, coins or tokens, cashless tickets or vouchers, electronic funds transfers or the like into the currency acceptor, a signal is sent by way of bus 246 to the I/O board and to EGM processor board 202 which, in turn, assigns an appropriate number of credits for play in accordance with the game program. The player may further control the operation of the gaming machine by way of other peripherals 244, for example, to select the amount to wager via the buttons 20. The game starts in response to the player operating a start mechanism such as the handle 34, button 20 such as a SPIN/RESET button or a touch screen icon. The game program includes a random number generator to provide a display of randomly selected indicia on one or more displays such as the primary game display 14 as shown in FIG. 1. In some embodiments, the random generator may be physically separate from gaming device 10; for example, it may be part of a central determination host system which provides random game outcomes to the game program. Finally, EGM processor board 202 under control of the game program and OS compares the outcome to an award schedule. The set of possible game outcomes may include a subset of outcomes related to the triggering and play of a feature or bonus game. In the event the displayed outcome is a member of this subset, EGM processor board 202, under control of the game program and by way of I/O Board, may cause feature game play to be presented on the primary game display 14 and/or any secondary display(s) 18.

Predetermined payout amounts for certain outcomes, including feature game outcomes, are stored as part of the game program. Such payout amounts are, in response to instructions from processor board 202, provided to the player in the form of coins, credits or currency via I/O board and a pay mechanism, which may be one or more of a credit meter, a coin hopper, a voucher printer, an electronic funds transfer protocol or any other payout means known or developed in the art.

In various embodiments, game programs are stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In an embodiment, the remote storage device is housed in a remote server such as a downloadable gaming server. The gaming machine may access the remote storage device via a network connection, including but not limited to, a local area network connection, a TCP/IP connection, a wireless connection, or any other means for operatively networking components together. Optionally, other data including graphics, sound files and other media data for use with the gaming terminal are stored in the same or a separate memory device (not shown). Some or all of the game programs and its associated data may be loaded from one memory device into another, for example, from flash memory to random access memory (RAM).

In one or more embodiments, peripherals may be connected to the system over Ethernet connections directly to the appropriate server or tied to the system controller inside the gaming terminal using USB, serial or Ethernet connections. Each of the respective devices may have upgrades to their firmware utilizing these connections.

GMU 206 includes an integrated circuit board and GMU processor and memory including coding for network communications, such as the G2S (game-to-system) protocol from the Gaming Standards Association, Las Vegas, Nev., used for system communications over the network. As shown, GMU 206 may connect to the card reader 32 through bus 248 and may thereby obtain player information and transmit the information over the network through bus 236. Gaming activity information may be transferred by the EGM Processor Board 202 to GMU 206 where the information may be translated into a network protocol, such as S2S, for transmission to a server, such as a player tracking server, where information about a player's playing activity may be stored in a designated server database.

PIB 208 includes an integrated circuit board, PID processor, and memory which includes an operating system, such as Windows CE, a player interface program which may be executable by the PID 208 processor together with various input/output (I/O) drivers for respective devices which connect to PID 208, such as player tracking module 28, and which may further include various games or game components playable on PID 208 or playable on a connected network server and PID 208 is operable as the player interface. PID 208 connects to card reader 32 through bus 218, player tracking display 30 through video decoder 250 and bus 216, such as an LVDS or VGA bus.

As part of its programming, the PID 208 processor executes coding to drive player tracking display 30 and provide messages and information to a player. Touch screen circuitry 252 interactively connects PTM display 30 and video decoder 250 to PID 208 such that a player may input information and causes the information to be transmitted to PID 208 either on the player's initiative or responsive to a query by PID 208. Additionally soft keys 254 connect through bus 212 to PID 208 and operate together with the player tracking display 30 to provide information or queries to a player and receive responses or queries from the player. PID 208, in turn, communicates over the CMS/SMS network through Ethernet switch 226 and busses 230, 234 and with respective servers, such as a player tracking server.

PTMs 28 are linked into the virtual private network of the system components in gaming terminal 10. The system components include the player tacking module 28 (e.g. Bally iVIEW ® device) (‘iView” is a registered trademark of Bally Gaming, Inc.) processing board 202 and game monitoring unit (GMU) processing board 202. These system components may connect over a network to the slot management system (such as a commercially available Bally SDS/SMS) and/or casino management system (such as a commercially available Bally CMP/CMS).

The GMU 206 system component has a connection to the base game through a serial SAS connection and is connected to various servers using, for example, HTTPs over Ethernet. Through this connection, firmware, media, operating system software, gaming machine configurations can be downloaded to the system components from the servers. This data is authenticated prior to installation on the system components.

The system components include the PTM 28 processing board and game monitoring unit (GMU) 206. The GMU 206 and PTM 28 can be combined into one like the commercially available Bally GTM iVIEW device. This device may have a video mixing technology to mix the EGM processor's video signals with the iVIEW display onto the top box monitor or any monitor on the gaming device.

The PTM 28 may also interface with a switcher and router device of the type described in U.S. Pub. App. 2009/0149253 entitled “Video Switcher and Touch Router Method for a Gaming Machine” filed Jan. 8, 2009 and incorporated by reference. Instead of providing the PTM display 30, the switcher and router device (e.g. DM) provides for the content normally display at the PTM display 30 to be displayed at and share display real estate with one or more of the primary or secondary displays 14, 18.

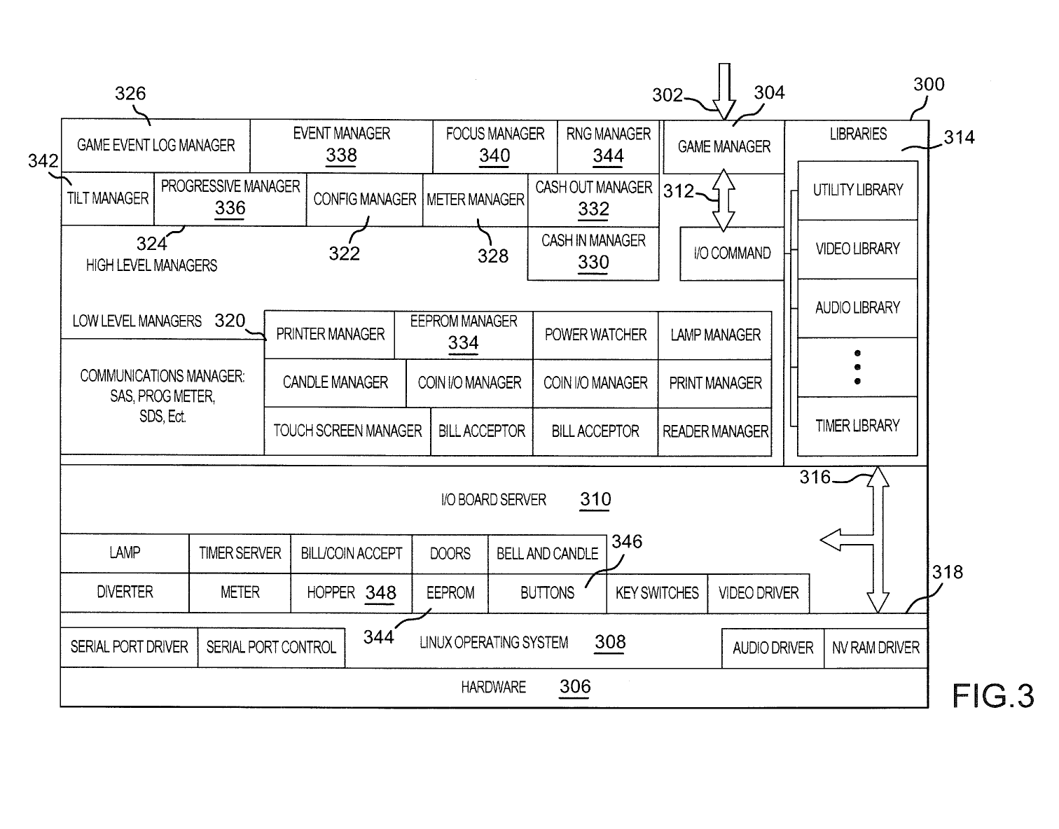

In accordance with one or more embodiments, FIG. 3 is a functional block diagram of a gaming kernel 300 of a game program under control of gaming terminal processor board 202. The game program uses gaming kernel 300 by calling into application programming interface (API) 302, which is part of game manager 304. The components of game kernel 300 as shown in FIG. 3 are only illustrative, and should not be considered limiting. For example, the number of managers may be changed, additional managers may be added or some managers may be removed without deviating from the scope and spirit of the invention.

As shown in the example, there are three layers: a hardware layer 306; an operating system layer 308, such as, but not limited to, Linux; and a game kernel layer having game manager 304 therein. In one or more embodiments, the use of an operating system layer 308, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel 300 executes at the user level of the operating system layer 308, and itself contains a major component called the I/O board server 310. To properly set the bounds of game application software (making integrity checking easier), all game applications interact with gaming kernel 300 using a single API 302 in game manager 304. This enables game applications to make use of a well-defined, consistent interface, as well as making access points to gaming kernel 300 controlled, where overall access is controlled using separate processes.

For example, game manager 304 parses an incoming command stream and, when a command dealing with I/O comes in (arrow 312), the command is sent to an applicable library routine 314. Library routine 314 decides what it needs from a device, and sends commands to I/O board server 310 (see arrow 316). A few specific drivers remain in operating system layer 308′s kernel, shown as those below line 318. These are built-in, primitive, or privileged drivers that are (i) general (ii) kept to a minimum and (iii) are easier to leave than extract. In such cases, the low-level communications is handled within operating system layer 308 and the contents passed to library routines 314.

Thus, in a few cases library routines may interact with drivers inside operating system layer 308, which is why arrow 316 is shown as having three directions (between library routines 314 and I/O board server 310, or between library routines 314 and certain drivers in operating system layer 308). No matter which path is taken, the logic needed to work with each device is coded into modules in the user layer of the diagram. Operating board server 310 layer is kept as simple, stripped down, and common across as many hardware platforms as possible. The library utilities and user-level drivers change as dictated by the game cabinet or game machine in which it will run. Thus, each game cabinet or game machine may have an industry standard EGM processing board 202 connected to a unique, relatively dumb, and as inexpensive as possible I/O adapter board, plus a gaming kernel 300 which will have the game-machine-unique library routines and I/O board server 310 components needed to enable game applications to interact with the gaming machine cabinet. Note that these differences are invisible to the game application software with the exception of certain functional differences (i.e., if a gaming cabinet has stereo sound, the game application will be able make use of API 302 to use the capability over that of a cabinet having traditional monaural sound).

Game manager 304 provides an interface into game kernel 300, providing consistent, predictable, and backwards compatible calling methods, syntax, and capabilities by way of game application API 302. This enables the game developer to be free of dealing directly with the hardware, including the freedom to not have to deal with low-level drivers as well as the freedom to not have to program lower level managers 320, although lower level managers 320 may be accessible through game manager 304's interface if a programmer has the need. In addition to the freedom derived from not having to deal with the hardware level drivers and the freedom of having consistent, callable, object-oriented interfaces to software managers of those components (drivers), game manager 304 provides access to a set of upper level managers 324 also having the advantages of consistent callable, object-oriented interfaces, and further providing the types and kinds of base functionality required in casino-type games. Game manager 304, providing all the advantages of its consistent and richly functional game application API 302 as supported by the rest of game kernel 300, thus provides a game developer with a multitude of advantages.

Game manager 304 may have several objects within itself, including an initialization object (not shown). The initialization object performs the initialization of the entire game machine, including other objects, after game manager 304 has started its internal objects and servers in appropriate order. In order to carry out this function, the kernel's configuration manager 322 is among the first objects to be started; configuration manager 322 has data needed to initialize and correctly configure other objects or servers.

The upper level managers 324 of game kernel 300 may include game event log manager 326 which provides, at the least, a logging or logger base class, enabling other logging objects to be derived from this base object. The logger object is a generic logger; that is, it is not aware of the contents of logged messages and events. The game event log manager's 326 job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 328 manages the various meters embodied in the game kernel 300. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 328 receives its initialization data for the meters, during start-up, from configuration manager 322. While running, the cash in manager 330 and cash out manager 332 call the meter manager's 328 update functions to update the meters. Meter manager 328 will, on occasion, create backup copies of the soft meters by storing the soft meters' readings in EEPROM. This is accomplished by calling and using EEPROM manager 334.

In accordance with still other embodiments, progressive manager 336 manages progressive games playable from the game machine. Event manager 338 is generic, like game event log manager 326, and is used to manage various gaming machine events. Focus manager 340 correlates which process has control of various focus items. Tilt manager 342 is an object that receives a list of errors (if any) from configuration manager 322 at initialization, and during game play from processes, managers, drivers, etc. that may generate errors. Random number generator manager 344 is provided to allow easy programming access to a random number generator (RNG), as a RNG is required in virtually all casino-style (gambling) games. Random number generator manager 344 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 332 has the responsibility of configuring and managing monetary output devices. During initialization, cash out manager 332, using data from configuration manager 322, sets the cash out devices correctly and selects any selectable cash out denominations. During play, a game application may post a cash out event through the event manager 338 (the same way all events are handled), and using a call back posted by cash out manager 332, cash out manager 332 is informed of the event. Cash out manager 332 updates the credit object, updates its state in non-volatile memory, and sends an appropriate control message to the device manager that corresponds to the dispensing device. As the device dispenses dispensable media, there will typically be event messages being sent back and forth between the device and cash out manager 332 until the dispensing finishes, after which cash out manager 332, having updated the credit manager and any other game state (such as some associated with meter manager 328) that needs to be updated for this set of actions, sends a cash out completion event to event manager 338 and to the game application thereby. Cash in manager 330 functions similarly to cash out manager 332, only controlling, interfacing with, and taking care of actions associated with cashing in events, cash in devices, and associated meters and crediting.

In a further example, in accordance with one or more embodiments, I/O board server 310 may write data to the gaming machine EEPROM memory, which is located in the gaming machine cabinet and holds meter storage that must be kept even in the event of power failure. Game manager 304 calls the I/O library functions to write data to the EEPROM. The I/O board server 310 receives the request and starts a low priority EEPROM manager 334 thread within I/O board server 310 to write the data. This thread uses a sequence of 8 bit command and data writes to the EEPROM device to write the appropriate data in the proper location within the device. Any errors detected will be sent as IPC messages to game manager 304. All of this processing is asynchronous.

In accordance with one embodiment, button module 346 within I/O board server 310, polls (or is sent) the state of buttons every 2 ms. These inputs are debounced by keeping a history of input samples. Certain sequences of samples are required to detect a button was pressed, in which case the I/O board server 310 sends an inter-process communication event to game manager 304 that a button was pressed or released. In some embodiments, the gaming machine may have intelligent distributed I/O which debounces the buttons, in which case button module 346 may be able to communicate with the remote intelligent button processor to get the button events and simply relay them to game manager 304 via IPC messages. In still another embodiment, the I/O library may be used for pay out requests from the game application. For example, hopper module 348 must start the hopper motor, constantly monitor the coin sensing lines of the hopper, debounce them, and send an IPC message to the game manager 304 when each coin is paid.

Further details, including disclosure of lower level fault handling and/or processing, are included in U.S. Pat. No. 7,351,151 issued Apr. 1, 2008 entitled “Gaming Board Set and Gaming Kernel for Game Cabinets” the disclosure of which is incorporated herein by explicit reference.

Referring to FIGS. 4A and B, an example of a gaming system 801 is shown in accordance with one or more embodiments. Gaming system 801 may include one casino or multiple locations (herein referred to collectively as a casino enterprise) and generally includes a network of gaming terminals 803 (including gaming devices 10 of the type as described in FIG. 1), floor management system (SMS) 805, and casino management system (CMS) 807. SMS 805 may include load balancer 811, network services server 813, player tracking module 28, iView (PTM 28) content servers 815, certificate services server 817, floor radio dispatch receiver/transmitters (RDC) 819, floor transaction servers 821 and game engines 823 (where the gaming terminals 803 operate server based or downloadable games), each of which may connect over network bus 825 to gaming terminals 803. CMS 807 may include location tracking server 831, WRG RTCEM (William Ryan Group Real Time Customer Experience Management from William Ryan Group, Inc. of Sea Girt, N.J.) server 833, data warehouse server 835, player tracking server 837, biometric server 839, analysis services server 841, third party interface server 843, slot accounting server 845, floor accounting server 847, progressives server 849, promo control server 851, bonus game (such as Bally Live Rewards) server 853, download control server 855, player history database 857, configuration management server 859, browser manager 861, tournament engine server 863 connecting through bus 865 to server host 867 and gaming terminals 803. The various servers and gaming terminals 803 may connect to the network with various conventional network connections (such as, for example, USB, serial, parallel, RS485, Ethernet). Additional servers which may be incorporated with CMS 807 include a responsible gaming limit server (not shown), advertisement server (not shown), and a control station server (not shown) where an operator or authorized personnel may select options and input new programming to adjust each of the respective servers and gaming terminals 803. SMS 805 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

The gaming terminals 803 include various peripheral components that may be connected with USB, serial, parallel, RS-485 or Ethernet devices/architectures to the system components within the respective gaming machine. The GMU 507 (shown as GMU 206 in FIG. 2A) has a connection to the base game through a serial SAS connection. The system components in the gaming cabinet may be connected to the servers using HTTPs or G2S protocols over Ethernet. Using CMS 807 and/or SMS 805 servers and devices, firmware, media, operating systems, and configurations may be downloaded to the system components of respective gaming devices for upgrading or managing floor content and offerings in accordance with operator selections or automatically depending upon CMS 807 and SMS 805 master programming. The data and programming updates to gaming terminals 803 are authenticated using conventional techniques prior to install on the system components.

In various embodiments, any of the gaming terminals 803 may be a mechanical reel spinning slot machine, video slot machine, video poker machine, video Bingo machine, Keno machine, or a gaming device offering one or more of the above described games including an interactive wheel feature. Alternately, gaming terminals 803 may provide a game with an accumulation-style feature game as one of a set of multiple primary games selected for play by a random number generator, as described above. A gaming system 801 of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. Published Application 2008/0139305, entitled “Networked System and Method for Group Gaming,” filed on Nov. 9, 2007, which is hereby incorporated by reference in its entirety for all purposes.

The gaming system 801, among other functionalities such as slot accounting (i.e. monitoring the amount wagered (“drop”), awards paid) and other casino services, includes the player tracking CMS/CMP server 837 and/or data warehouse 835 storing player account data. This data includes personal data for players enrolled in the casino players club sometimes referred to as a loyalty club. An example of the personal data is the player's name, address, SSN, birth date, spouse's name and perhaps personal preferences such as types of games, preferences regarding promotions, player rating level, available player comp points (points accumulated based upon commercial “spend” activity with the enterprise including gaming and which may be redeemed or converted into cash or merchandise) and the like. As is known in the industry and according to the prior art, at enrolment the player is assigned a created account in the player tracking CMS/CMP server 837 and is issued a player tracking card having a machine readable magnetic stripe.

The system 801 may also include electronic transfer of funds functionality. For example, a player having accumulated $100 at a gaming terminal 10 may decide to “cash out” to play another gaming terminal 10. The player, for example using the PTM 28 to initiate communication with the system 801 for example server 837 to upload the value from the gaming terminal 10 into an electronic account associated with the player's account. The player may choose to upload all or a portion of the funds the player's established electronic account. The system would prompt the player to enter their PIN (or obtain biometrical confirmation as to the player's identity) and upload the chosen amount to their account. When the player moves to another gaming terminal 10 he/she inserts their player loyalty card into the card reader 32 to access their account. A prompt provides for the player to request funds from their account. Entering their PIN (or biometric identifier) the player can input the desired amount which is downloaded to their gaming terminal 10 for play.

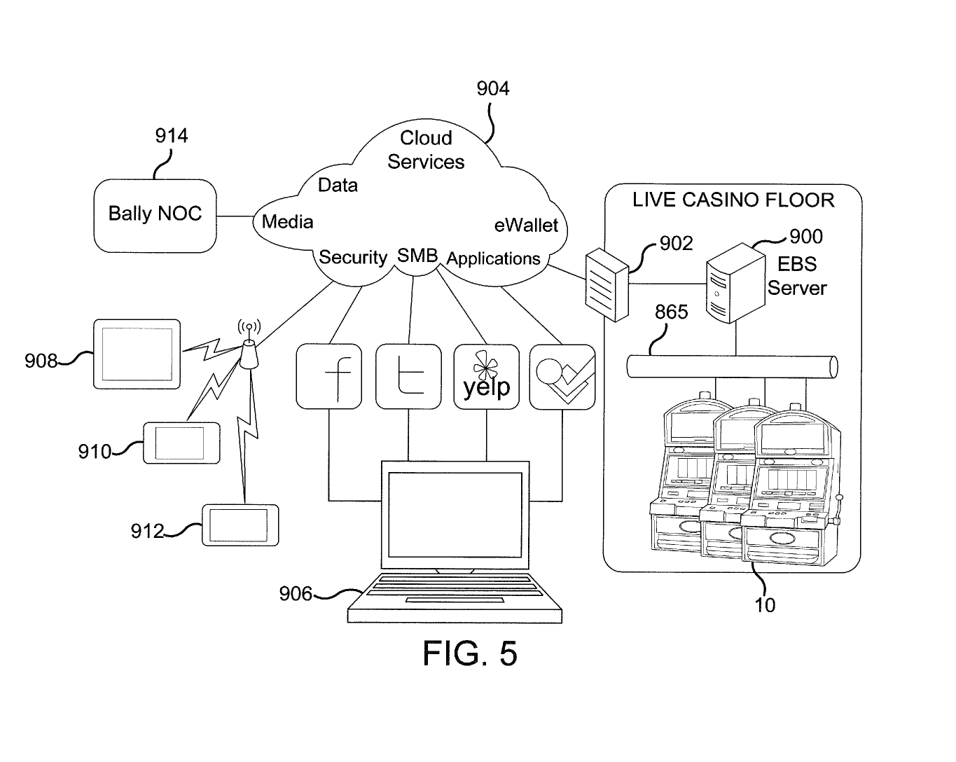

Portions of the present invention may be implemented or promoted by or through a system as suggested in FIG. 5. At 801 is the gaming system which may be hosted at a casino property enterprise, across several casino enterprises or by a third party host. As described above the gaming system 801 has a network communication bus 865 providing for communication between the gaming devices 10 and various servers. To provide the functionality illustrated in FIG. 5, a feature server 900, such as a Bally Elite Bonusing Server, is connected to the network communication bus 865 for communication to the gaming system 801, the gaming devices 10 and the various servers and other devices as described above. Through a secure network firewall 902 the feature server 900 is in communication with a cloud computing/storage service 904 which may be hosted by the casino enterprise, a licensed third party or if permitted by gaming regulators an unlicensed provider. For example the cloud service 904 may be as provided by Microsoft® Private Cloud Solutions offered by Microsoft Corp. of Redmond, Wash., USA. The cloud service 904 provides various applications which can be accessed and delivered to, for example, personal computers 906, portable computing devices such as computer tablets 908, personal digital assistants (PDAs) 910 and cellular devices such as telephones 910 and smart phones 912. For example the cloud service 904 may provide and support the enterprise applications in association with the feature server 900. The cloud service 904 may also facility the delivery of content, including games, to user/players by supporting updates and advertising through the enterprise applications to the remote device user/player. The cloud service 904 includes security provide for secure communication with the cloud service 904 between the player/users and the cloud service 904 and between the cloud service 904 and the gaming system 801. Security applications may be through encryption, the use of personal identification numbers (PINS) or other devices and systems. As suggested in FIG. 5 the cloud service 904 stores player/user data retrieved from players/users and from the gaming system 801 and feature server.

The players/users may access the cloud service 904 and the applications and data provided thereby through the Internet or through broadband wireless cellular communication systems and any intervening sort range wireless communication such as WiFi. The players/users may access the applications and data through various social media offerings such as Facebook, Twitter, Yelp, MySpace or LinkedIn or the like.

The cloud service 904 may also host game applications to provide virtual instances of games for free, promotional, or where permitted, P2P (Pay to Play) supported gaming. Third party developers may also have access to placing applications with the cloud service 904 through, for example a national operations center (Bally NOC 914). A game software manufacturer such as Bally Gaming, Inc. may also provide game applications on its own or on behalf of the casino enterprise.

Other media such as advertising, notices (such as an upcoming tournament) promotions and surveys may also be provided to and through the cloud service 904. When a player/user accesses the cloud service 904 certain media may be delivered to the player/user in a manner formatted for their application and device.

With specific reference to various embodiments, the present invention system and method is broadly directed to providing a community gaming experience to players across numerous gaming devices of the same or different manufacture. While the various embodiments of the community gaming experience can be delivered and viewed by players at a PTM display 30, in a preferred embodiment a DM video switcher and router of the typed disclosed in U.S. Pub. App. 2009/0149253 (the disclosure of which has been incorporated by reference) is utilized to control the primary display 14 to display both the primary game and the community game. In this fashion the player has a more direct interface with the community game experience.

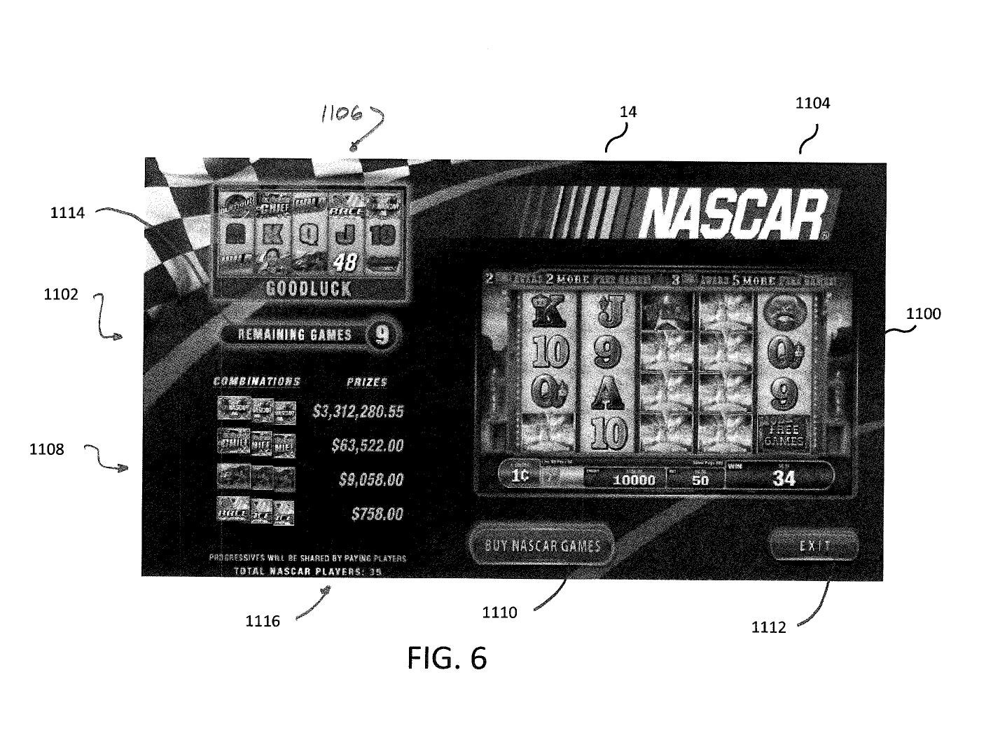

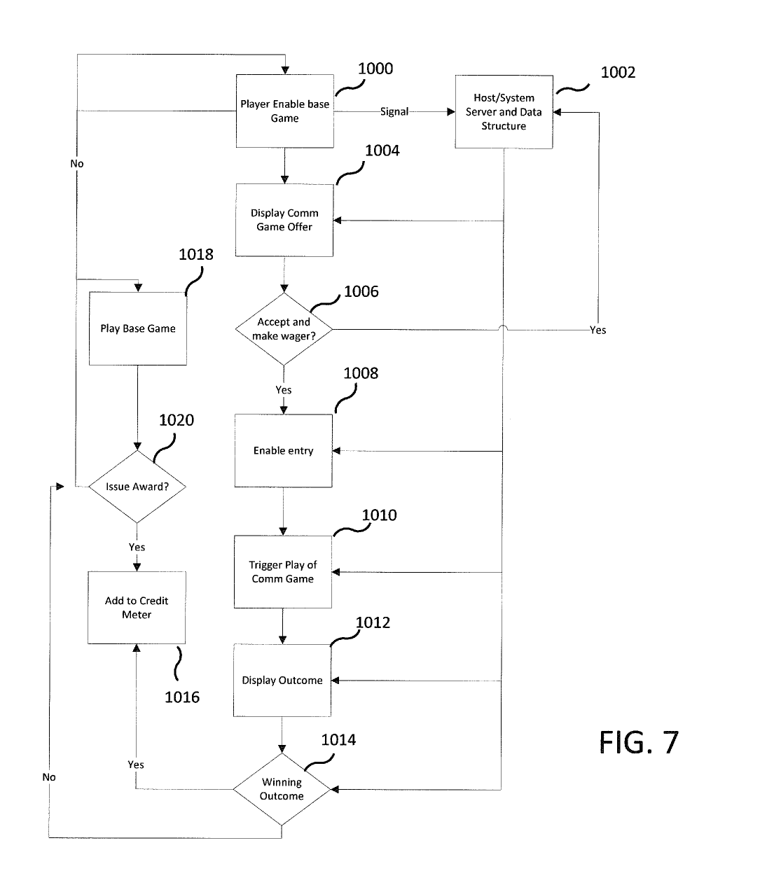

With reference to FIGS. 6 and 7 an embodiment of the present invention is described. At 1000 (FIG. 7) a player enables the gaming device 10 as by inserting their loyalty card into the card reader 32 or inserts cash/coins or otherwise established credits for wagering. When enabled the gaming device 10 GMU or other system communication device sends a signal to the host/system server 1002 which may be a separate host/server or may by functionally represented by one or more of the servers of FIGS. 4A,B. The host server 1002, in response to the signal sends data to the gaming device 10 to cause the DM to allocate real estate at the primary game display 14, with the display of the base game, to display at 1004 a community game as shown in FIG. 6. In FIG. 6 the primary game display 14 is controlled to display the base game 1100 at the right side of the primary game display 14 and community game content 1102 to the left side with a community game banner 1104 above the base game 1100. It should be understood that in embodiments the community game operates independent of the base game 1100. That is, the community game operates on its own automatic schedule and does not depend upon the play or outcome of the base game. Further, while only one base game 1100 is shown, the base game play may include more than one instance of a game such as by displaying multiple instances of the same or related base games. Further, while the description herein refers to base games, the term embraces any feature or secondary or bonus games which may be associated with or driven by the base game. According to the illustrative embodiment, the community game is a video reel-type slot game 1106 having reels with symbols. Other games could be used as well such as Keno, Lottery, Bingo, Roulette or the like. The presentation of the community game content also includes an associated award schedule 1108 informing the player of winning combinations and the awards associated with each. The community game content 1102 also includes the display of player action touch screen buttons including an accept button 1110 by which the player may accept to buy entries or wager for the community game. An exit touch screen button 1112 enables the player to exit from the shared display and return to the singular display of the base game. It should be understood that where the community game content 1102 is removed from the display to return to the display of only the base game, the base game includes a reverse button whereby the player may call-up the community game content 1102.

Continuing with FIG. 6, the community game content 1102 also displays a remaining games meter 1114 and at 1116 a total player meter to indicate the total number of players currently participating in the community game. The remaining games meter 1114 displays the number of a series N of bought community games remaining for the player.

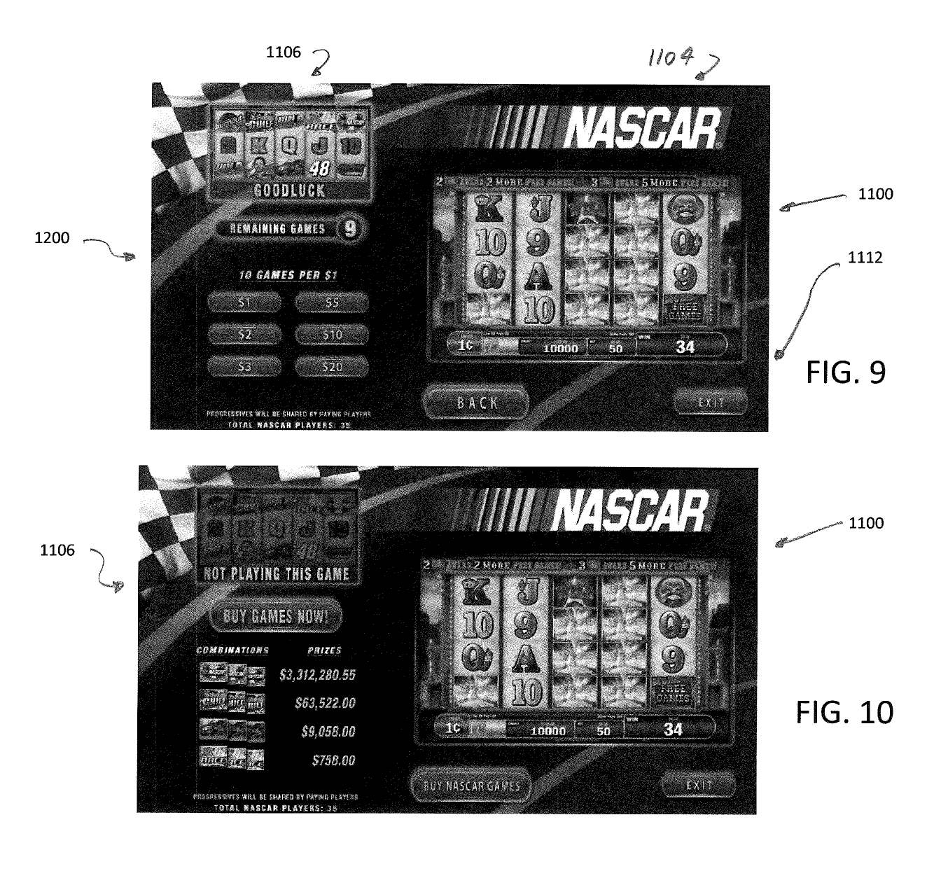

With the community game content 1102 displayed the player at 1106 (FIG. 7) decides whether to accept the offer to play the community game. If they decide they then enter a wager to play. A minimum wager (w) is required to participate such as, for example, 10¢. Wagers are deducted from the gaming device 10 credit meter. In an alternative or additional embodiment entries may be purchased with loyalty points or through casino marketing funds such as with promotional vouchers or the like or the players may wager from an established electronic account. The player can select to wager more per game and can elect to play a series of N future games. FIG. 9 shows at 1200 an example of a series of touch screen buttons by which a player can wager on a series of N future games. For example, if the player touches the “$1” button, they would be entitled to ten plays, at 10¢ each, of the community game. The remaining games meter 1114 tracks the number of remaining bought games of the series N due the player. As disclosed above, the player may elect to wager more on each community game, e.g. 50¢ per game, to be entitled to a greater share of any community winning award. The wager(s) for the community games are independent of the wagers for the base game. At 1008 the host/system server 1002 enables the players bought entries. It should be understood that where the present invention is implemented for free or promotional play the wager w may be fictitious credits.

Play of the community game may be played automatically by the host/system server 1002 such as, for example, every 20 seconds and the player has no control as to the start of the game. It may be triggered by other events such as a particular symbol or combination from a base game or a mystery trigger such as participating gaming device 10 aggregate wagers or the percentage allocated to the community game jackpots matching a trigger amount or other randomly selected trigger. Preferably, where the game is based upon a trigger event, i.e. is not automatic, the triggering events occur quite frequently. Once the player has enabled their entry they will participate in the next community game play/spin.

The base game 1100 includes its meters as are well known in the art such as credit meter, bet meter, win meter, a denomination indicator and an information call-up touch screen button.

At 1010 the play of the next community game is triggered or occurs automatically and at 1012 the community game outcome is displayed. All participating players share the same winning or losing outcome of the community game. In the event a player has chosen not to participate the community game is still displayed to the player as shown for example in FIG. 10, as being faded or grayed. Thus, seeing the community game and perhaps a winning outcome, the non-participating player may have an incentive to participate. To display the community game the host/system server 1002 selects one or more random numbers and controls the community game to display spinning reels and stopping to define an outcome. In an embodiment the community game software engine at the host/server is configured as a slot machine to randomly select reel stops and present outcomes as in a Class III gaming device as defined in Title 25, United States Code §2701 et seq. In an embodiment the host/system server 1002 may randomly select an outcome award and reverse map the award to the display of a corresponding winning or losing outcome as in central determination gaming. The software engine may also operate as a Class II game, as described in 25 USC §2701 et seq. Any suitable random outcome selection function can be used.

In an embodiment the community game provides one or more progressive prizes. These prizes are funded based upon the wagers to participate in the community game. Portions of the wagers are allocated to one or more progressive prizes as well as to “seed” the start-up values for the pool after a progressive prize has been awarded. The odds for obtaining a progressive outcome are chosen to make sure the progressive prize pools are adequately funded. Marketing funds and amounts related to the use of loyalty points to purchase entries may also be taken into account. The funding may take into account a certain amount being allocated to the hosting venue for operating and administering the community game. Where the community game is offered over a wide area network across, for example, multiple casino properties, across state lines or where/when permitted over the Internet or through play with broadband-connected devices, the progressive prizes may grow quickly and to large amounts.

If, at 1014 in FIG. 7, there is a winning outcome at 1016 the prize amount allocated to the players, as described herein, is added to the players' gaming device 10 credit meter. Of course if the amount requires a hand pay, the award is paid by hand. If the outcome is a losing outcome a losing community game outcome is displayed. It should be noted that the community game outcome is shared and is common among all entrant players in the game. This builds a sense of a common goal among the players to obtain a winning outcome and generates community excitement when indeed a winning outcome is obtained.

To illustrate that the play of the base game and the community game are separate, FIG. 7 shows at 1018 the play of the base game and if, at 1020 the player is entitled to an award, the award is issued to the credit meter.

In the event the player plays their credits off while they still have one or more community games, the player can wait out the play of the remaining games. Alternatively the player may leave the game by, for example, cashing out which will issue a payment to the player in the amount equal to the amount(s) wagered to play the remaining community games. The player may of course re-fund their credits on the gaming device 10 and resume play of the base game while the series of N bought games plays out.

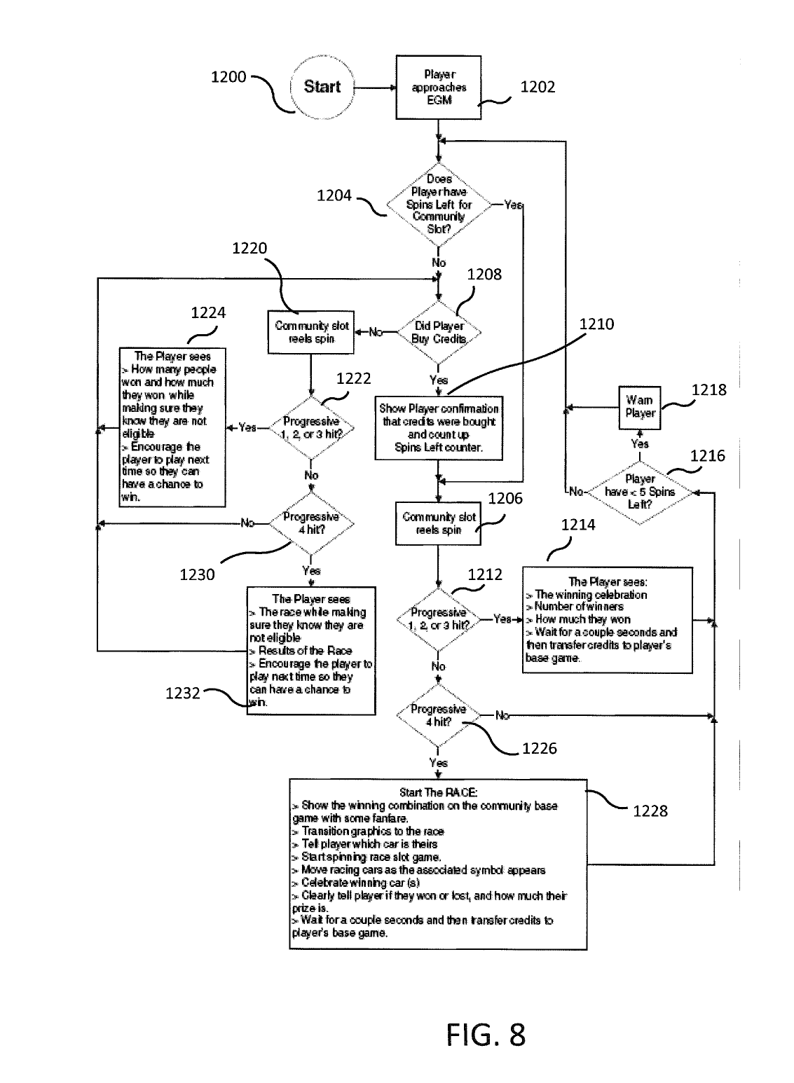

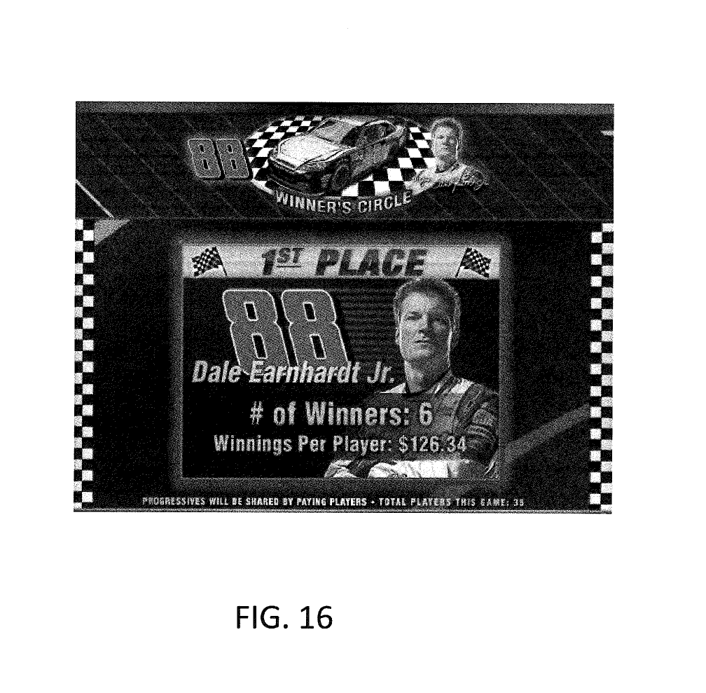

Except for the embodiments described below, any winning outcome is paid to participating players on a pro rata basis. For example, if each of 30 players wagered 10¢ on the community game, they would each receive 1/30 of any award. Where a player has elected to wager more on the community game, they are entitled to a greater award. For example, if there are 30 participating players and one player wagered 50° and the remaining players each wagered 10¢, the prize would be split 34 ways with the player who bet 50¢ getting 5/35 of the award and the remaining 29 players getting 1/35 of the award each. In an alternate embodiment one or more entrant players may be randomly selected to receive all or a portion of the prize. Players who wagered more for their entry would have a greater chance to receive an award.

Where an award of the community game is relatively small, dividing up the small award between all of the entrant players would be anti-climatic. Accordingly, in an embodiment, in such an instance a competitive community bonus game may be conducted to determine distribution of all or a portion of the award. FIGS. 8, 11-16 illustrate an embodiment of the community competitive bonus game. At 1200 the sequence is started. At 1202 the player approaches or has been recognized as a community game entrant. As described this step may be satisfied by the player having elected to participate in the community game by lodging one or more wagers therefore. At 1204 the system determines if the player has any community games remaining in a bought series N of future games. If at 1204 it is determined that the player has spins left in the bought series N, the player at 1206 is entitled to participate in the next community game. If it is determined that the player does not have any entry in the community game, i.e. no spins left, at 1208 it is determined if the player has bought one or more additional games and if so, at 1210 the display at the players gaming device 10 is controlled to display a confirmation of the game(s) remaining in the series N or that the player is otherwise entered in the community game. At 1206 the community game reels are spun and a community, shared, outcome is produced and displayed to the entrant players. According to this example, the community game offers three top level progressives and a fourth, smaller value progressive. FIG. 10 shows an example of a pay table for the community game having such a schedule of awards. It should be understood that more of fewer awards could be offered. If at 1212 it is determined that one of the top level progressive awards has been won, at 1214 the community game content 1102 is controlled to display, for example, a celebratory display for the players, indicate the number of entrants (winning players) and their award shares. After a few seconds, the indicated awards are transferred to the winning players' gaming device 10 credit meters. For any entrant players having bought a series of N games, at 1216 it is determined if any player has less than five games remaining in their bought series N and if so at 1218 a warning is issued to such player(s) inviting them to buy more games for the series N. This warning may be displayed in the community game content 1102 and/or may be an audible warning. If there are more than five games are left at 1216 the logic is returned to 1204.

Returning to 1204, if it is determined that the player has no more entries in the community game and at 1208 the player does not purchase any more, at 1220 the community game is played regardless and at 1222 the game determines if any of the top three progressive awards have been won. Any 1224 the non-entrant player's display is controlled to display how many entrant players participated in the award to encourage the non-entrant players to buy into the community game.

If at 1212 is determined that none of the top level progressive prizes have been one at 1226 it is determined if the lower, fourth level, progressive prize has been won. If not, there is no award and the logic returns to 1216 to process as described above. If the fourth level progressive has been won, at 1228 the process moves to the competitive bonus game phase, an example of which will be described. At 1228 the winning combination is displayed to the players (entrants and non-entrants) and the community game content 1102 is controlled to display the features of the bonus game as hereinafter described.

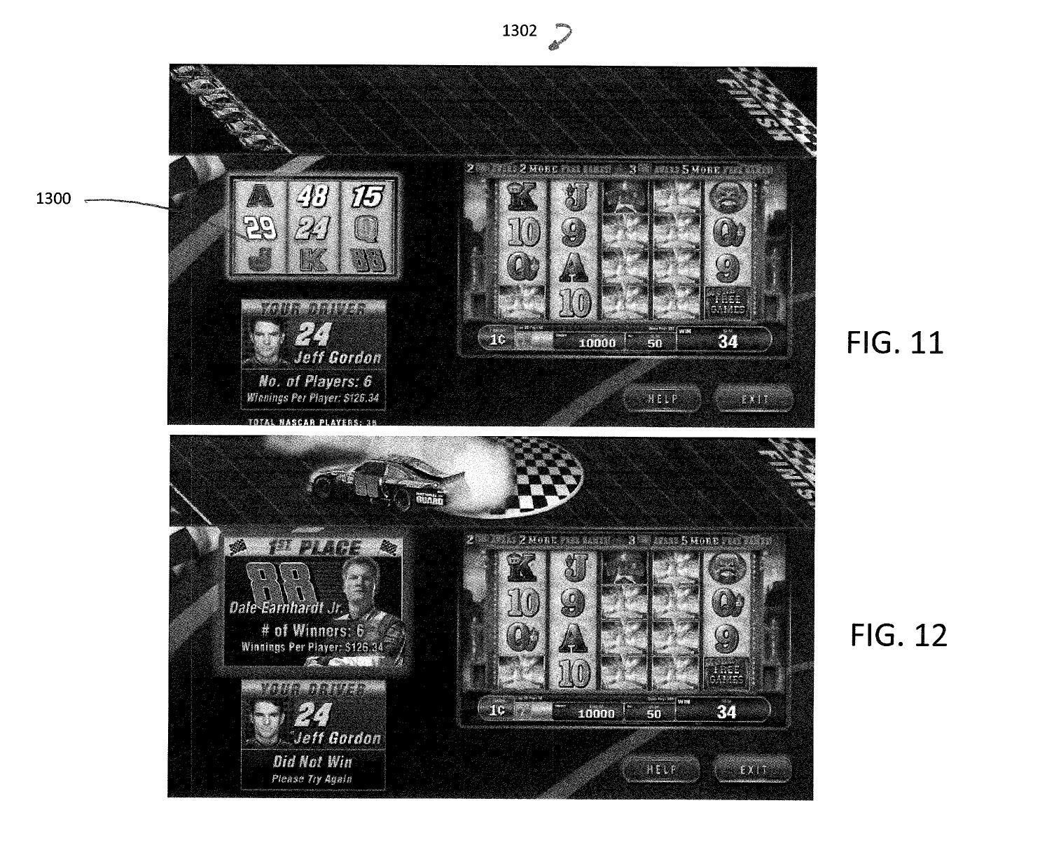

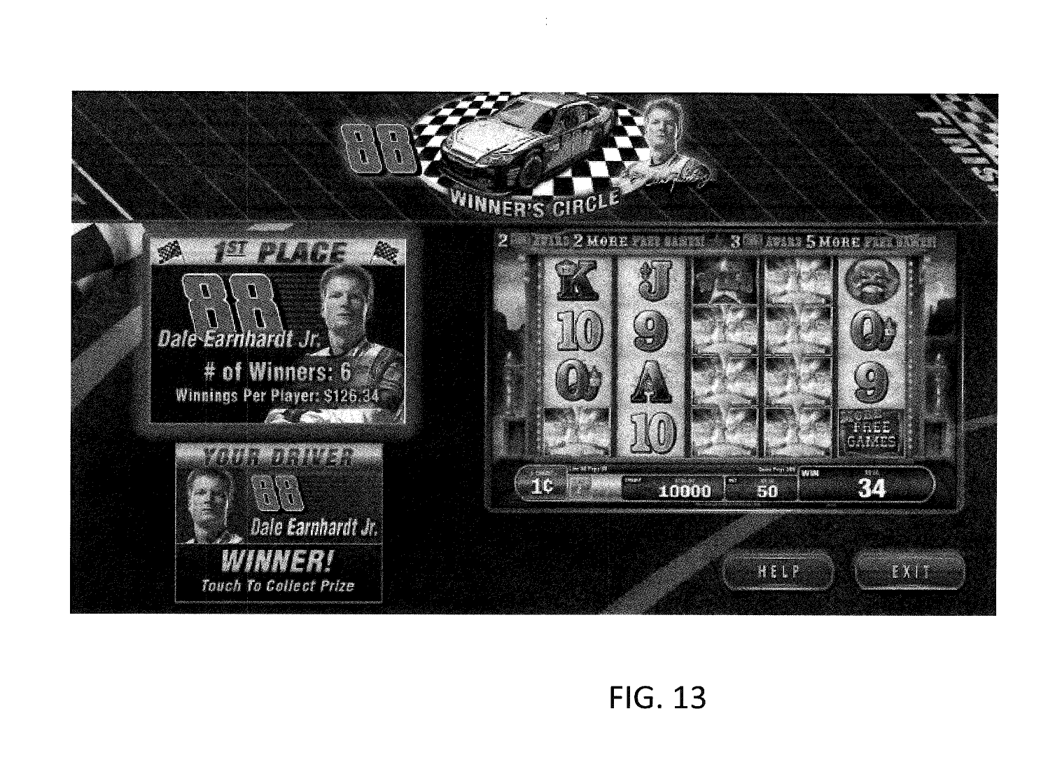

The community bonus game, according to an embodiment, may be competitive race, in this example, an automobile race. At the top of the community game content 1102 is displayed a race track with a plurality of virtual competitors poised to begin the race. At 1228 the players select or are assigned to each race competitor. Based upon the number of competitors and the number of entrants, multiple players may select or be assigned to a competitor. In the example, entrant players select/are assigned to race cars in the field. Players are, at 1228, informed of their assigned competitor as well as the number of other players assigned to that particular competitor as suggested in FIG. 11. The community game slot game 1106 is transformed into a slot game having configured, virtual reel strips, including symbols reflecting each competitor such as, in the case, competitors' car numbers. The transformed game 1106 is shown in FIG. 11 at 1300. After assignment of all entrant players to competitors, the bonus game starts by serially producing outcomes at the slot game 1300. Each time a competitor's car number appears, that competitor is moved on a shared race display 1302 toward a finish line. An overhead or bank video display may also display the race for the players and onlookers. Serial outcomes of the game 1300 eventually move a competitor to win at the finish line. At 1228 the winning competitor is identified, a celebratory display such as at FIG. 13 showing the car in the winner's circle. Player's are also informed as to the amount of the award they have won. All entrant players having the winning competitor may share the award pro-rata. For players having wagered more than the minimum their share may be increased as described above. Alternatively, players have wagered more than the minimum may be entitled to select/be assigned to multiple competitors to increase their chances of winning. Awards are then sent to each winning player's gaming device 10 credit meter.

The slot game 1300 is controlled by software engine at the host/server 1002 and preferably has its virtual reel strips configured to give each competitor the same odds of winning. Alternatively the host/server 1002 may randomly select the winning and reverse map the display of spins at the slot game 1300. To build excitement, the game 1300 may be configured to, on average, take twenty serial spins or about two minutes to produce a winner.

If the player(s) were assigned to a losing competitor the host/server 1002 controls their display to indicate that the player(s) lost and to display a losing graphic or video presentation as suggested in FIG. 12.

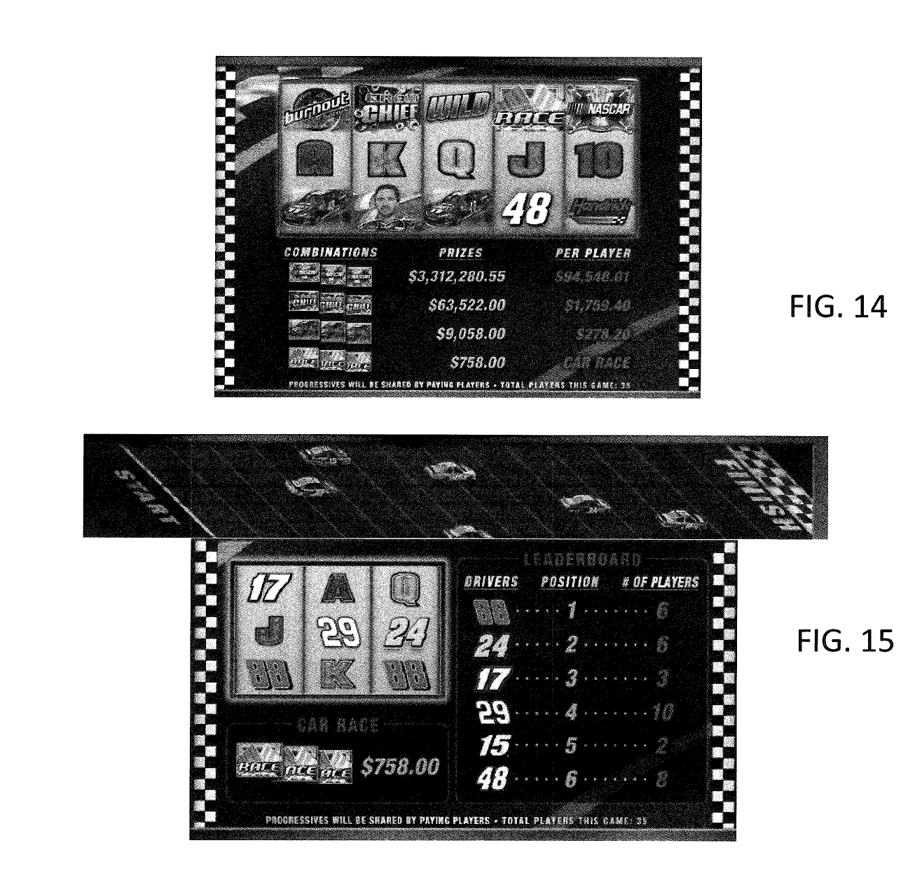

FIGS. 14-16 illustrate examples of the bonus game displays, the competitive race and winning notification.

Returning to FIG. 8, where the player is a non-entrant, if at 1230 the fourth level progressive is not hit, the player is returned to 1208. If indeed the fourth level progressive has been hit at 1232, the non-entrant player is informed that they are not a participant and the bonus game race and results are displayed to encourage the player to buy community game entries.

The community and bonus game may be displayed at the primary game display 14 as described above, secondary display 18, PTM display 30 or at the touch screen button deck of the type described in U.S. Pub. App. 2010/0113140, the disclosure of which has been incorporated by reference. The base and community game as described herein may be practiced for entertainment purposes on computers and cellular devices. Where legalized, the same may also be practiced remotely on a pay-to-play (P2P) basis.

The game may also be played via a mobile gaming platform such as by providing the above described game as a primary game or, as described above, an adjunct to a primary game. As but an example, where legal, Internet of mobile based gaming may enable players to play wager-based gaming such as Poker or virtual slot machines. In such a environment the aforementioned secondary game may be displayed as part of the player's display and played in the manner described. In an alternative embodiment the secondary game may be played as a non-wager-based, entertainment only game as well.

The foregoing description, for purposes of explanation, uses specific nomenclature and formula to provide a thorough understanding of the invention. It should be apparent to those of skill in the art that the specific details are not required in order to practice the invention. The embodiments have been chosen and described to best explain the principles of the invention and its practical application, thereby enabling others of skill in the art to utilize the invention, and various embodiments with various modifications as are suited to the particular use contemplated. Thus, the foregoing disclosure is not intended to be exhaustive or to limit the invention to the precise forms disclosed, and those of skill in the art recognize that many modifications and variations are possible in view of the above teachings.

What is claimed is:

1. A system for providing a community game to a plurality of gaming devices connected on a network, each gaming device including a display and configured to play a base wager game, said system comprising:
a host server in communication with said gaming devices over said network, said host server configured to provide data to said gaming devices for the display of a community game for play by players;
apparatus to communicate to said host server an entry in said community game by a player at a gaming device by risking an amount w;
said server configured to control a display at said gaming device to display a winning or a losing outcome for said community game, said outcome shared by all entrant players;
said server configured to issue an award A to all entrant players for a winning outcome by one or more of (a) sharing the award among said players according to each entrant player wager w or (b) distributing the award A according to a random distribution among said entrant players or (c) distributing the award according to a community competitive game between said entrant players.

2. The system of claim 1 comprising said host server configured to display said community game as a reel spinning game.

3. The system of claim 2 comprising said reel spinning game is a Class III type game

4. The system of claim 1 comprising said server is configured for distributing the award according to a competitive race game between a plurality of virtual competitors and said entrant players are assigned to a competitor.

5. The system of claim 4 comprising said server is configured to randomly select a winner from said virtual competitor and to distribute said award to entrant players assigned to the winning competitor.

6. The system of claim 4 comprising said server is configured to iteratively display outcomes of said community game the outcomes of which drive advancement of said competitors.

7. The system of claim 1 comprising said server is configured to provide a plurality of awards, at least one is distributed according to (a) and at one is distributed according to (c).

8. The system of claim 1 comprising said server is configured to allocate a portion of w to a progressive jackpot award A.

9. The system of claim 1 comprising triggering the play of the community games automatically.

10. The system of claim 1 comprising apparatus to communicate to said host server entries for a series of N community games by a player at a gaming device by risking an amount N×w.

11. The system of claim 10 comprising said server configured to display at each gaming device the number of plays of the community game series remaining for the player.

12. A method for providing a community game to a plurality of gaming devices connected on a network, each gaming device including a display and configured to play a base wager game, said method comprising:
configuring a host server to communication with said gaming devices over said network and to provide data to said gaming devices for the display of a community game for play by players;
enabling a player to enter in said community game at a gaming device by risking an amount w;
controlling a display at said gaming device to display a winning or a losing shared outcome for said community game;
issuing an award A to all entrant players for a winning outcome by one or more of (a) sharing the award among said players according to each entrant player wager w or (b) distributing the award A according to a random distribution among said entrant players or (c) distributing the award according to a community competitive game between said entrant players.

13. The method of claim 12 comprising distributing the award according to a competitive race game between a plurality of virtual competitors and said entrant players are assigned to a competitor.

14. The method of claim 13 comprising randomly selecting a winner from said virtual competitor and distributing said award to entrant players assigned to the winning competitor.

15. The method of claim 13 comprising iteratively displaying outcomes of said community game which drives advancement of said competitors.

16. The method of claim 12 comprising providing a plurality of awards, at least one is distributed according to (a) and at one is distributed according to (c).

17. The method of claim 12 comprising allocating a portion of w to a progressive jackpot award A.

18. The method of claim 12 comprising triggering the play of the community games automatically.

19. The method of claim 12 comprising enabling said players to make an entry of a series of N community games by a player at a gaming device by risking an amount N×w.

20. The method of claim 19 comprising displaying the number of plays of the community game series remaining for the player.
